(19) United States
(12) Patent Application Publication
(10) Pub. No.: US 2021/0374694 A1
(43) Pub. Date: Dec. 2, 2021

(54) SERVER, INFORMATION PROCESSING SYSTEM, AND COMPUTER READABLE RECORDING MEDIUM

(71) Applicant: TOYOTA JIDOSHA KABUSHIKI KAISHA, Toyota-shi (JP)

(72) Inventors: Shintaro MATSUTANI, Kariya-shi (JP); Misato YOKOTA, Tokyo (JP); Yumiko OSAKI, Tokyo (JP); Atsushi YONEKI, Chigasaki-shi (JP); Kazunari TSUTSUMI, Tokyo (JP); Mitsunori ISODA, Tokyo (JP); Yuzo YAMADA, Nagoya-shi (JP)

(73) Assignee: TOYOTA JIDOSHA KABUSHIKI KAISHA, Toyota-shi (JP)

(21) Appl. No.: 17/225,534

(22) Filed: Apr. 8, 2021

(30) Foreign Application Priority Data
May 29, 2020 (JP) 2020-094437

(51) Int. Cl. G06Q 20/06; G06Q 20/36

(52) U.S. Cl. CPC G06Q 20/065; G06Q 20/36

(57) ABSTRACT

A server includes a processor including hardware, the processor being configured to, regarding points given to users for each of a plurality of different settlement methods using electronic money, exchange points given to a first user for each of the plurality of different settlement methods with points given to a second user for each of the plurality of different settlement methods.

The present application claims priority to and incorporates by reference the entire contents of Japanese Patent Application No. 2020-094437 filed in Japan on May 29, 2020.

### BACKGROUND

The present disclosure relates to a server, an information processing system, and a computer readable recording medium.

JP 2012-208894 A discloses an electronic settlement method from a plurality of electronic money accounts.

### SUMMARY

A user may possess points given to electronic money for each of a plurality of different settlement methods. A user may receive a service such as point return by using electronic money. However, if a settlement method is not normally used, points given to the settlement method may not be effectively used.

There is a need for a server, an information processing system, and a computer readable recording medium storing a program enabling effective use of points given according to a plurality of different settlement methods.

According to one aspect of the present disclosure, there is provided a server including a processor including hardware, the processor being configured to, regarding points given to users for each of a plurality of different settlement methods using electronic money, exchange points given to a first user for each of the plurality of different settlement methods with points given to a second user for each of the plurality of different settlement methods.

### BRIEF DESCRIPTION OF THE DRAWINGS

FIG. 1 is a schematic diagram illustrating a schematic configuration of an information processing system according to an embodiment;

FIG. 2 is a block diagram illustrating functional blocks of the information processing system according to the embodiment;

FIG. 3 is a diagram illustrating an example of a case where points are exchanged between electronic wallets;

FIG. 4 is a sequence diagram illustrating a point exchange control flow; and

FIG. 5 is a diagram illustrating another example of a case where points are exchanged between electronic wallets.

### DETAILED DESCRIPTION

Hereinafter, a server, an information processing system, and a program according to an embodiment will be specifically described with reference to the drawings. The present disclosure is not limited to the embodiment described below.

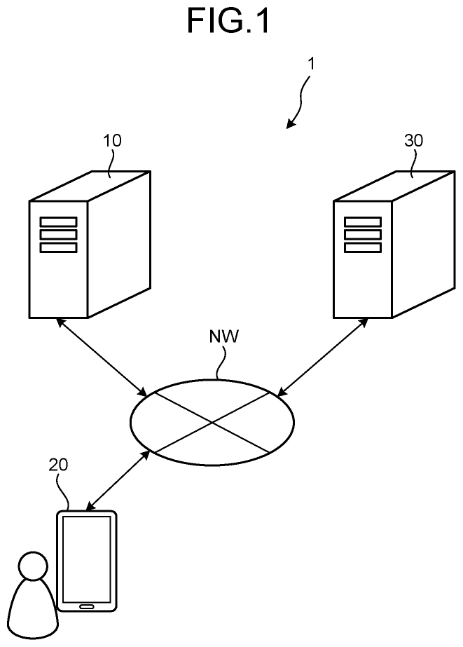

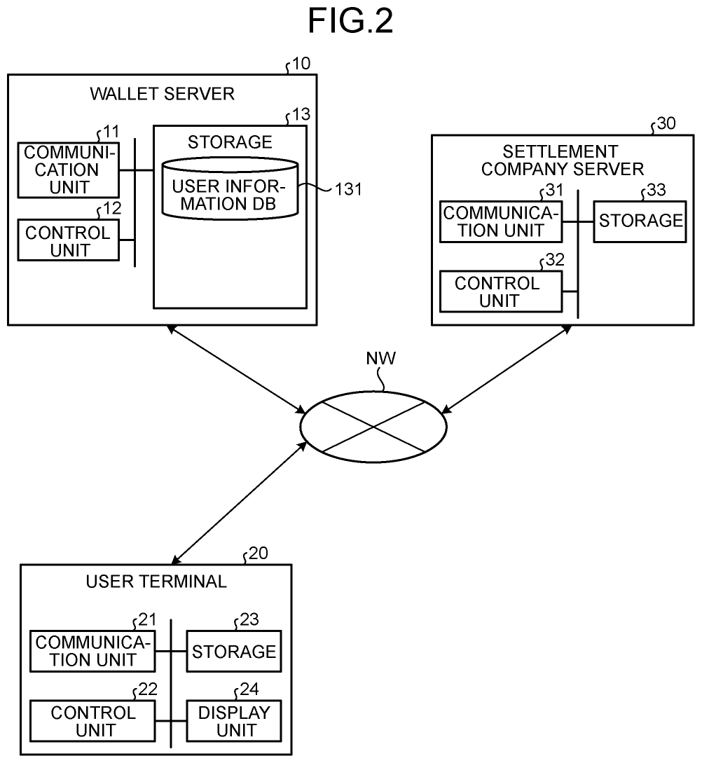

The configuration of the information processing system according to the embodiment will be described with reference to FIGS. 1 and 2. As illustrated in FIG. 1, an information processing system 1 of the embodiment includes a wallet server 10, a user terminal 20, and a settlement company server 30.

In the information processing system 1, the wallet server 10, the user terminal 20, and the settlement company server 30 are configured to be able to communicate with each other through a network NW. The network NW includes, for example, the Internet line network, a mobile phone line network, and the like.

The wallet server 10 is a server that collectively manages a wallet system, and is managed by an administrator of the wallet system. As illustrated in FIG. 2, the wallet server 10 includes a communication unit 11, a control unit 12, and a storage 13.

The communication unit 11 includes, for example, a Local Area Network (LAN) interface board, a wireless communication circuit for wireless communication, and the like. The communication unit 11 is connected to the network NW such as the Internet, which is a public communication network, or the like. The communication unit 11 communicates with the user terminal 20 and the settlement company server 30 by connecting to the network NW.

The control unit 12 includes a processor and a memory. The processor includes a central processing unit (CPU), a digital signal processor (DSP), a field-programmable gate array (FPGA), and the like. The memory is a main storage device, and includes a random access memory (RAM), a read only memory (ROM), or the like. The control unit 12 loads a program stored in the storage 13 into the work area of the memory (main storage device) and executes the program, and controls each of the components and the like through the execution of the program to implement functions that meet a predetermined purpose.

The storage 13 includes a recording medium such as an erasable programmable ROM (EPROM), a hard disk drive (HDD), and a removable medium. Examples of the removable medium include a disc recording medium such as a universal serial bus (USB) memory, a compact disc (CD), a digital versatile disc (DVD), and a Blu-ray (registered trademark) disc (BD). The storage 13 may store an operating system (OS), various programs, various tables, various databases (DB), and the like. The storage 13 has a user information database 131.

In the user information database 131, information about a user who uses the information processing system (hereinafter, referred to as “user information”) is stored. Examples of the user information include a user ID of a user who has registered to use the wallet system, a password, a name of the user (user name), user contact information (for example, an address, a telephone number, an email address, etc.), a usage registration history, information about a payment method registered as a deposit method, information about a payment method registered as a settlement method, a code number at the time of settlement, a category, presence/absence of an approver, presence/absence of usage restriction, and the like. Out of the user information, the user ID and the password are used for authentication processing such as login to the wallet server 10.

Further, the user information database 131 stores information about electronic wallets of the information processing system 1 (hereinafter, referred to as “wallet information”). An electronic wallet indicates a virtual deposit/withdrawal account of electronic money. Examples of the wallet information include a user ID, an electronic money balance, an electronic money deposit history, an electronic money usage history, and point information. Further, the wallet information includes information about settlement in the wallet system (hereinafter, referred to as “settlement information”). Examples of the settlement information include a user ID, a settlement method used for settlement (for example, electronic money payment, scan payment, code payment, etc.), a settlement history, and the like. In the wallet information, a plurality of settlement methods is registered. The point information is given for each of a plurality of different settlement methods. That is, in the wallet information, points are managed for each settlement method.

The user terminal 20 is a computer terminal used by a user. Examples of the user terminal 20 include a smartphone, a mobile phone, a tablet terminal, a wearable computer, a personal computer, or the like used by a user.

The user terminal 20 includes a communication unit 21, a control unit 22, a storage 23, and a display unit 24. The communication unit 21, the control unit 22, and the storage 23 included in the user terminal 20 are physically similar to the communication unit 11, the control unit 12, and the storage 13 included in the wallet server 10. The user terminal 20 may be any terminal as long as it is a mobile terminal capable of transmitting and receiving information to and from the wallet server 10 through the network NW.

The control unit 22 functions as a display control unit, a deposit method registration unit, a settlement method registration unit, a deposit processing unit, and a settlement processing unit through the execution of a program stored in the storage 23.

When the control unit 22 functions as a display control unit, the control unit 22 controls the display content on the display unit 24. The control unit 22 displays various screens on the display unit 24 based on an operation (touch operation, flick operation, etc.) of a user. Examples of display screens include a login screen when logging in to the wallet system, a settlement screen when making a settlement by scan payment, etc., a usage history screen indicating a list of usage histories such as a settlement, a payment history detail screen indicating details of payment histories, a deposit screen when depositing electronic money in an electronic wallet. In addition, the control unit 22 transitions screen to screen based on an operation of a user.

When the control unit 22 functions as a deposit method registration unit, the control unit registers a deposit method for depositing electronic money. The deposit method indicates a method of depositing electronic money in an electronic wallet, which is a virtual deposit/withdrawal account. Examples of the deposit method include a bank account and a credit card out of the payment methods. By registering a bank account and a credit card as deposit methods, deposit of electronic money in an electronic wallet becomes possible. The payment method indicates a method that serves as a funding source when a settlement is made. Examples of the payment method include a bank account, a credit card, and an electronic money balance in an electronic wallet. A bank account is linked to the credit card, and a use amount of each card is withdrawn from the bank account at a later date.

The control unit 22 transmits, to the wallet server 10, a deposit method registration request asking for registration of a plurality of different payment methods operated by a plurality of companies as deposit methods to the electronic wallet. When the control unit 12 of the wallet server 10 receives a deposit method registration request from the user terminal 20, the control unit 12 stores, as user information, the payment methods included in the deposit method registration request in the user information database 131 of the storage 13. As a result, the payment methods are registered in the user information database 131 as deposit methods.

When the control unit 22 functions as a settlement method registration unit, the control unit 22 registers the payment methods to be registered as deposit methods also as settlement methods. The “settlement method” indicates a method of making a settlement using a payment method. Examples of the settlement method include scan payment, electronic money payment, and code payment. All of the scan payment, the electronic money payment, and the code payment are settlement methods using the balance of the electronic money in the electronic wallet.

For example, the control unit 22 transmits a settlement request to the wallet server 10 or a store terminal for making a settlement using any of a plurality of preset settlement methods (electronic money payment, scan payment, code payment) using electronic money deposited in the electronic wallet. At that time, in a case where an electronic money payment is made, the control unit 22 transmits a payment request to the store terminal through the short-range wireless communication unit. A scan payment is a settlement made when a barcode or QR code (registered trademark) posted at a store is read with a camera or the like of the user terminal 20. When a code payment is made, the control unit 22 transmits a payment request to the store terminal by having a reading unit such as the code reader or the like of the store terminal read a barcode or QR code (registered trademark) displayed on the user terminal 20. When a scan payment is made, the barcode or QR code (registered trademark) displayed on the store terminal such as a cash register may be read by the user terminal 20.

When the control unit 22 functions as a deposit processing unit, the control unit 22 deposits electronic money in an electronic wallet. The control unit 22 transmits a deposit request to the wallet server 10 for depositing electronic money in the electronic wallet by a payment method registered as a deposit method. When the control unit 12 of the wallet server 10 receives the deposit request from the user terminal 20, the control unit 12 increases the electronic money balance in the electronic wallet based on deposit amount information included in the deposit request. That is, the control unit 12 updates the wallet information stored in the storage 13 according to the increased amount of the electronic money balance in the electronic wallet.

When the control unit 22 functions as a settlement processing unit, the control unit 22 makes a settlement by the payment method. For example, when a scan payment is made, the control unit 22 transmits a payment request (settlement request) to the wallet server 10 by reading a QR code (registered trademark) posted at the store with the camera or the like of the user terminal 20.

When the control unit 22 functions as a settlement processing unit, the control unit 22 may also make a settlement by a payment method other than the electronic money balance in the electronic wallet (for example, a bank account or a credit card). For example, when a deposit method registration request is transmitted from the user terminal 20 to the wallet server 10, the control unit 22 transmits a registration request, which causes the payment methods included in the deposit method registration request to be registered as settlement methods, to the wallet server 10. That is, when the control unit 22 registers, to the wallet server 10 as a deposit method, a payment method (for example, a bank account of bank X), the control unit 22 automatically registers the payment method (the bank account of bank X) also as a settlement method. “Registering a payment method as a settlement method” means making the payment method available as a payment source for settlement. In other words, it means making a scan payment possible using the bank account of bank X as the payment source. When the control unit 12 of the wallet server 10 receives a registration request from the user terminal 20, the control unit 12 stores, as user information, the payment method included in the registration request in the user information database 131. Thus, the payment method is registered as a settlement method. Then, the control unit 22 transmits a payment request to the wallet server 10 for making a payment using any of a plurality of settlement methods by a bank account or a credit card. When the control unit 12 receives a payment request (settlement request) from the user terminal 20, the control unit 12 transmits settlement amount information included in the payment request to the settlement company server 30. Then, the settlement processing is performed by information communication between the wallet server 10 and the settlement company server 30.

In the storage 23, data of various screens that the control unit 22 displays on the display unit 24 is stored. Further, in the storage 23, the user information, the wallet information, and the like are temporarily stored as needed.

The display unit 24 includes, for example, a touch panel display, and has an input function for accepting an operation by a user's finger, a pen, or the like, and a display function for displaying various types of information based on the control by the control unit 22.

The settlement company server 30 is a server for managing an account and a credit card of a user, and is provided in a financial institution (for example, a bank, a shinkin bank, a credit union, a labor bank, etc.) and a credit card company. The settlement company server 30 includes a communication unit 31, a control unit 32, and a storage 33. The communication unit 31, the control unit 32, and the storage 33 included in the settlement company server 30 are physically similar to the communication unit 11, the control unit 12, and the storage 13 included in the wallet server 10.

In the storage 33, account information and credit card information for each of users of the wallet system is stored. Examples of the account information include a name of a user, an account number, an account balance, a deposit/withdrawal history, and the like. Examples of the credit card information include a name of a user, a credit card number, a credit card expiry date, a usage limit, a card usage history, and the like.

In the information processing system 1 configured in this way, each of a plurality of users uses a user terminal 20. Then, the wallet server 10 registers an electronic wallet for each user. In the electronic wallet, for example, four settlement methods: “A Pay”, “B Pay”, “C Pay”, and “D Pay”, are registered as a plurality of different settlement methods. “A Pay”, “B Pay”, “C Pay”, and “D Pay” may be any of settlement by a bank account, settlement by a credit card, or settlement by electronic money. Settlement by a bank account is a settlement method in which the settlement amount is withdrawn directly from the bank account. To the credit card, a bank account is linked and a use amount of the credit card is withdrawn from the bank account at a later date. To the electronic wallet, a deposit method such as a bank account and a credit card, which are methods of depositing in electronic money is linked, enabling deposit in electronic money. When the electronic money is of a prepaid type, which may be deposited by cash or the like in advance, a deposit method such as a bank account or a credit card does not need to be linked to the electronic money.

Furthermore, in the electronic wallet, points are given to each settlement method by a service such as point return. That is, points associated with “A Pay”, points associated with “B Pay”, points associated with “C Pay”, and points associated with “D Pay” exist independently in the same electronic wallet. This point information is stored in the storage 13 of the wallet server 10.

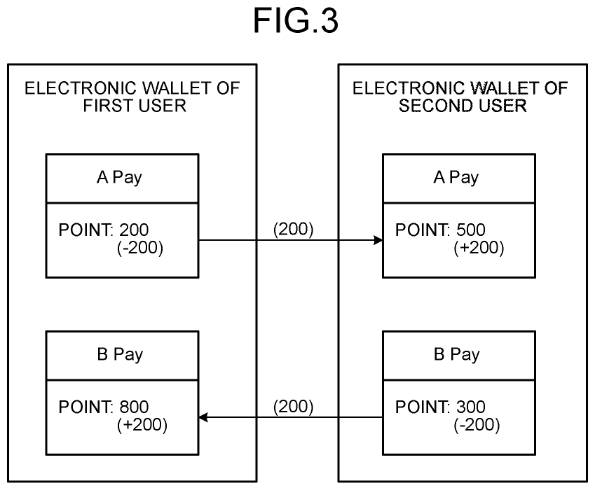

Then, in the information processing system 1, points given for each settlement method of the electronic wallet may be exchanged between users. For example, it is possible to exchange points between two specific users. The wallet server 10 performs the point addition/subtraction processing based on a point exchange request. Here, with reference to FIG. 3, a case where points are exchanged between an electronic wallet of a first user and an electronic wallet of a second user will be described as an example.

Based on the point information stored in the storage 13, the wallet server 10 exchanges points of “A Pay” and points of “B Pay” between the electronic wallets of the first user and the second user, as illustrated in FIG. 3. In the example illustrated in FIG. 3, all 200 points given to “A Pay” of the first user are exchanged to points of “B Pay”.

The wallet server 10 subtracts 200 points from “A Pay” of the first user and adds the points to “A Pay” in the electronic wallet of the second user. As a result, the points of “A Pay” of the first user become 0 points by subtracting 200 points from 200 points. On the other hand, the points of “A Pay” in the second user's electronic wallet become 700 points by adding 200 points to 500 points.

Then, 200 points are subtracted from “B Pay” in the second user's electronic wallet, and the points are added to “B Pay” in the first user's electronic wallet. As a result, the points of “B Pay” of the second user become 100 points by subtracting 200 points from 300 points. On the other hand, the points of “B Pay” of the first user become 1000 points by adding 200 points to 800 points.

In this way, in the wallet server 10, the same number of points given for different settlement methods may be exchanged between different users.

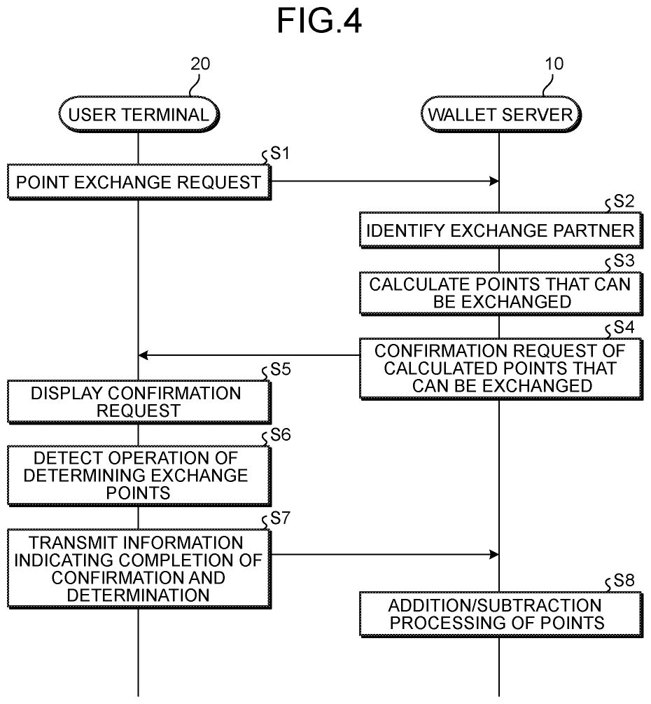

FIG. 4 is a sequence diagram illustrating a point exchange control flow.

The user terminal 20 transmits, to the wallet server 10, a point exchange request for exchanging points given for each of a plurality of different settlement methods in its own electronic wallet to points possessed by another user (step S1). The point exchange request includes information such as information specifying an exchange partner and the number of points desired to be exchanged. For example, a user operates the user terminal 20 to transmit a point exchange request including information about selection of an exchange partner to the wallet server 10. By accepting this operation, the user terminal 20 performs the processing of step S1.

Upon receiving the point exchange request, the wallet server 10 identifies the exchange partner (step S2). In step S2, the exchange partner is identified by referring to the storage 13 based on the information about selection of the exchange partner included in the point exchange request.

Further, the wallet server 10 calculates points that may be exchanged (step S3). In step S3, the number of points possessed by the exchange partner is identified, and the points that may be exchanged are calculated. In this case, exchange points are calculated by comparing points possessed by the first user with points possessed by the second user.

It is assumed, for example, that the point exchange request is a request by the first user for exchange of 500 points of “A Pay” to points of “B Pay”. In a case where the second user who is the exchange partner possesses only 300 points of “B Pay” as illustrated in FIG. 3 at that time, points that may be exchanged are calculated to be “300 points”. That is, the number of points smaller than the required value included in the point exchange request is calculated to be exchangeable points.

Then, the wallet server 10 transmits a confirmation request of the calculated points that may be exchanged to the user terminal 20 (step S4).

Upon receiving the confirmation request from the wallet server 10, the user terminal 20 displays information about the confirmation request on the display unit 24 (step S5). In step S5, information about the number of points possessed by the exchange partner, a settlement method for which points may be exchanged, and points that may be exchanged is displayed. Further, the display unit 24 displays a display screen capable of accepting an input operation from the user. For example, since the second user as the exchange partner possesses only 300 points of “B Pay”, the screen indicating that points that may be exchanged are 300 points is displayed.

The user terminal 20 detects an operation of determining exchange points by the user (step S6). In step S6, it is detected that an input operation of the exchange points has been performed on an input screen displayed in step S5. For example, the first user who uses the user terminal 20 may determine the exchange points up to 300 points that may be exchanged. At that time, the first user performs an operation of determining “200 points” as exchange points on the user terminal 20.

Then, the user terminal 20 transmits information indicating the completion of confirmation of points that may be exchanged and determination of the exchange points to the wallet server 10 (step S7). For example, the information indicating that the exchange point is determined to be “200 points” is transmitted from the user terminal 20 to the wallet server 10.

Upon receiving the completion information from the user terminal 20, the wallet server 10 performs addition/subtraction processing of points to be exchanged (step S8). In step S8, the numbers of points in the electronic wallets are added or subtracted such that the numbers of points of the users as exchange targets change based on the point information stored in the storage 13. An example of the addition/subtraction processing in step S8 is illustrated in FIG. 3. For example, point addition/subtraction processing is performed based on information indicating that the exchange points are “200 points”.

As described above, according to the embodiment, the points given to the settlement methods frequently used in the electronic wallets may be exchanged between users. Thus, the points given for a plurality of different settlement methods may be effectively used.

Further, in the information processing system 1, it is possible to add up points given to a plurality of settlement methods and exchange the points. For example, the first user adds up points of “A Pay” and points of “B Pay”, and transmits, to the wallet server 10, a point exchange request with the points as the exchange source and points of “C Pay” as the exchange destination from the user terminal 20. In this case, the first user has selected “A Pay” and “B Pay” as the exchange source, and has selected “C Pay” as the exchange destination. The wallet server 10 compares the points of “C Pay” possessed by the second user with the added-up number of points of “A Pay” and “B Pay” that the first user requested to exchange. Then, when point exchange is performed using the number of points that may be exchanged, the points of “A Pay”, “B Pay”, and “C Pay” move between the electronic wallet of the first user and the electronic wallet of the second user.

In addition, points to be exchanged may be points with usage conditions such as time-limited points. In this case, the wallet server 10 may perform point exchange to exchange time-limited points with time-limited points.

Furthermore, it is also possible to exchange time-limited points with normal points. However, if it is close to the time limit of the time-limited points, the time limit may expire before the points are used, and the time-limited points may expire. Therefore, it is considered that the value of time-limited points having a time limit that is close is lower than that of normal points. Therefore, when exchanging the time-limited points with normal points, the wallet server 10 may set a difference between the numbers of points to be exchanged.

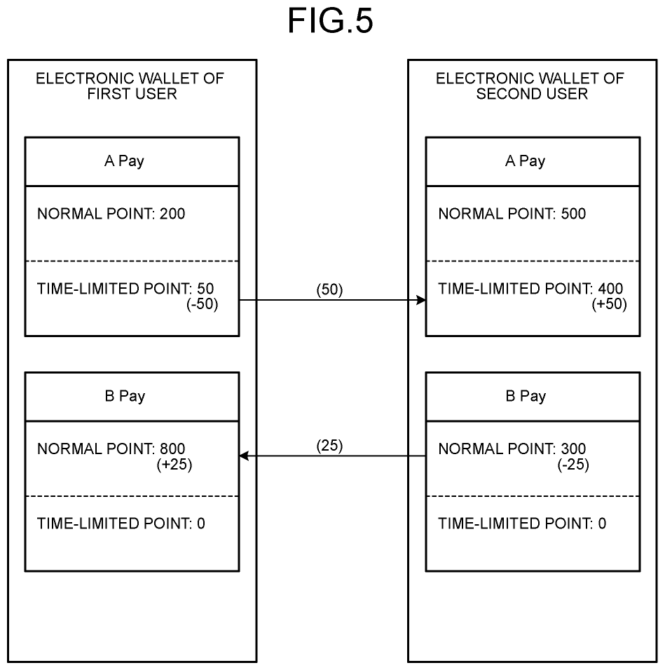

For example, as illustrated in FIG. 5, the wallet server 10 exchanges time-limited points with normal points by using time-limited points given to “A Pay” in the first user's electronic wallet as the exchange source. All 50 points that the first user possesses as time-limited points of “A Pay” are given to time-limited points of “A Pay” of the second user. At that time, 50 points are subtracted from the time-limited points of “A Pay” of the first user, and 50 points are added to the time-limited points of “A Pay” of the second user. Then, the time-limited points will be exchanged with normal points that are less than the time-limited points.

Furthermore, in the example illustrated in FIG. 5, the number of time-limited points as the exchange source is 50 while the number of normal points as exchange destination is 25. The 25 normal points possessed by the second user for “B Pay” are given to normal points of the first user for “B Pay”. At that time, 25 points are subtracted from the normal points of “B Pay” of the first user, and 25 points are added to the normal points of “A Pay” of the second user.

That is, as illustrated in FIG. 5, the total number of points possessed within the same electronic wallet may be changed after the point exchange. The first user use does not use “A Pay” frequently, and thus there is a possibility that the 50 points, which are time-limited points, will expire. It may then be advantageous for the first user to exchange the time-limit points with normal points of “B Pay” even though the total number of points possessed decreases. On the other hand, the second user frequently uses “A Pay”, and thus it may be advantageous for the second user that the total number of points possessed increases since the second user has an opportunity to use time-limited points before expiration even though the time limit thereof is close. When it is advantageous for users who exchange points as described above, it is possible to set a difference between the numbers of points to be exchanged.

The case where the exchange partner is specified and the number of points desired to be exchanged is set at the time of the point exchange request has been described, but the point exchange system by the information processing system 1 may operate in other ways. For example, the wallet server 10 may match users in response to a point exchange request. In this case, the wallet server 10 refers to a plurality of pieces of user information in the storage 13 and extracts a piece of user information that matches the point exchange request. Then, the wallet server 10 transmits the extracted piece of user information, the number of points that may be exchanged, and a request for selecting an exchange partner to the user terminal 20 as a confirmation request.

According to the present disclosure, points given for a plurality of different settlement methods may be effectively used.

Although the d has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A server comprising
a processor comprising hardware, the processor being configured to, regarding points given to users for each of a plurality of different settlement methods using electronic money, exchange points given to a first user for each of the plurality of different settlement methods with points given to a second user for each of the plurality of different settlement methods.

2. The server according to claim 1, wherein when exchanging points between the first user and the second user, the processor is configured to compare points given to the first user with points given to the second user to calculate exchangeable points.

3. The server according to claim 2, wherein when calculating exchangeable points, the processor is configured to compare number of points possessed by the first user with number of points possessed by the second user for each of the plurality of different settlement methods.

4. The server according to claim 1, wherein
the points include first points given for a first settlement method out of the settlement methods and second points given for a second settlement method out of the settlement methods, and
when exchanging the first points possessed by the first user with the second points possessed by the second user, the processor is configured to add number of points corresponding to the first points of the first user to be exchanged to the first points of the second user, subtract the added number of points from the second points of the second user, and add the subtracted number of points to the second points of the first user.

5. The server according to claim 1, wherein in a case where a point exchange request specifies a destination for giving points by an exchange to be one of the settlement methods and includes selection of points as exchange source from a plurality of settlement methods, the processor is configured to exchange a sum of points selected as the exchange source between the first user and the second user.

6. The server according to claim 2, wherein
when calculating exchangeable points, in a case where normal points are exchanged with normal points, the processor is configured to exchange same number of points as number of points specified by a point exchange request.

7. The server according to claim 2, wherein
when calculating exchangeable points, in a case where points with a usage condition are exchanged with normal points, the processor is configured to exchange normal points that are less than the points with the usage condition.

8. An information processing system comprising:
a user terminal comprising a first processor comprising hardware, the user terminal being used by a first user; and
a server comprising a second processor comprising hardware, wherein
the first processor is configured to transmit, to the server, a point exchange request regarding points given to users for each of a plurality of different settlement methods using electronic money, and
the second processor is configured to exchange, in response to the point exchange request, points given to the first user for each of the plurality of different settlement methods with points given to the second user for each of the plurality of different settlement methods.

9. The information processing system according to claim 8, wherein when exchanging points between the first user and the second user, the second processor is configured to compare points given to the first user with points given to the second user to calculate exchangeable points.

10. The information processing system according to claim 9, wherein when calculating exchangeable points, the second processor is configured to compare number of points possessed by the first user with number of points possessed by the second user for each of the plurality of different settlement methods.

11. The information processing system according to claim 8, wherein
the points include first points given for a first settlement method out of the settlement methods and second points given for a second settlement method out of the settlement methods, and
when exchanging the first points possessed by the first user with the second points possessed by the second user, the second processor is configured to add number of points corresponding to the first points of the first user to be exchanged to the first points of the second user, subtract the added number of points from the second points of the second user, and add the subtracted number of points to the second points of the first user.

12. The information processing system according to claim 8, wherein in a case where the point exchange request specifies a destination for giving points by an exchange to be one of the settlement methods and includes selection of points as an exchange source from a plurality of settlement methods, the second processor is configured to exchange a sum of points selected as the exchange source between the first user and the second user.

13. The information processing system according to claim 9, wherein when calculating exchangeable points, in a case where normal points are exchanged with normal points, the second processor is configured to exchange same number of points as the number of points specified by a point exchange request.

14. The information processing system according to claim 9, wherein when calculating exchangeable points, in a case where points with a usage condition are exchanged with normal points, the second processor is configured to exchange normal points that are less than the points with a usage condition.

15. A non-transitory computer-readable recording medium on which an executable program is recorded, the program causing a processor of a computer to execute:
regarding points given to users for each of a plurality of different settlement methods using electronic money, exchanging points given to a first user for each of the plurality of different settlement methods with points given to a second user for each of the plurality of different settlement methods.

16. The non-transitory computer-readable recording medium according to claim 15, wherein the program causes the processor to execute when exchanging points between the first user and the second user, comparing points given to the first user with points given to the second user to calculate exchangeable points.

17. The non-transitory computer-readable recording medium according to claim 16, wherein the program causes the processor to execute when calculating exchangeable points, comparing number of points possessed by the first user with number of points possessed by the second user for each of the plurality of different settlement methods.

18. The non-transitory computer-readable recording medium according to claim 15, wherein the program causes the processor to execute when exchanging first points, as points possessed by the first user, given for a first settlement method out of the settlement methods with second points, as points possessed by the second user, given for a second settlement method out of the settlement methods, adding number of points corresponding to the first points of the first user to be exchanged to the first points of the second user, subtracting the added number of points from the second points of the second user, and adding the subtracted number of points to the second points of the first user.

19. The non-transitory computer-readable recording medium according to claim 15, wherein the program causes the processor to execute in a case where a point exchange request specifies a destination for giving points by an exchange to be one of the settlement methods and includes selection of points as exchange source from a plurality of settlement methods, exchanging a sum of points selected as the exchange source between the first user and the second user.

20. The non-transitory computer-readable recording medium according to claim 15, wherein the program causes the processor to execute when calculating exchangeable points, in a case where points with a usage condition are exchanged with normal points, exchanging normal points that are less than the points with a usage condition.
